(19) United States
(12) Patent Application Publication
(10) Pub. No.: US 2002/0077927 A1
(43) Pub. Date: Jun. 20, 2002

(54) Internet shopping system and method

(76) Inventors: Philippe Lasnier, Quebec (CA); Gerald Poncet, Laval (CA); Richard Booth, Montreal (CA)

Correspondence Address: BROUILLETTTE KOSIE, 25th Floor, 1100 Rene-Levesque Blvd. West, Montreal, QC, H3B 5C9, CA

(21) Appl. No.: 09/765,312

(22) Filed: Jan. 22, 2001

(30) Foreign Application Priority Data
Dec. 15, 2000 (CA) 2,328,066

(51) Int. Cl. G06F 17/60

(52) U.S. Cl. 705/26; 705/27

(57) ABSTRACT

This invention relates to the electronic commerce area and more particularly the b2b2c (business to business to consumer) segment.

A system and method is provided which offers to online retailers (brick & mortar and pureplay) as well as manufacturers, a physical point of sales to promote & sell their products and services. This system and method will allow for a variety of business transactions: information collection and processing, product returns, sales of goods, sales of electronic information and other internet related services.

### FIELD OF THE INVENTION

This invention relates to the electronic area and more particularly the b2b2c (business to business to consumer) segment using the internet.

### BACKGROUND OF THE INVENTION

The InterNet is a worldwide interconnection of computer networks that communicate using a common protocol. Millions of computers, from low end personal computers to high-end super computers are coupled to the InterNet.

The InterNet grew out of work funded in the 1960s by the U.S. Defense Department's Advanced Research Projects Agency. For a long time, InterNet was used by researchers in universities and national laboratories to share information. As the existence of the InterNet became more widely known, many users outside of the academic/research community (e.g., employees of large corporations) started to use InterNet to carry electronic mail.

In 1989, a new type of information system known as the World-Wide-Web (“the Web”) was introduced to the InterNet. Early development of the Web took place at CERN, the European Particle Physics Laboratory. The Web is a wide-area hypermedia information retrieval system aimed to give wide access to a large universe of documents. At that time, the Web was known to and used by the academic/research community only. There was no easily available tool which allows a technically untrained person to access the Web.

The architecture of the Web follows a conventional client-server model. The terms “client” and “server” are used to refer to a computer's general role as a requester of data (the client) or provider of data (the server). Under the Web environment, Web browsers reside in clients and Web documents reside in servers. Web clients and Web servers communicate using a protocol called “HyperText Transfer Protocol” (HTTP). A browser opens a connection to a server and initiates a request for a document. The server delivers the requested document, typically in the form of a text document coded in a standard Hypertext Markup Language (HTML) format, and when the connection is closed in the above interaction, the server serves a passive role, i.e., it accepts commands from the client and cannot request the client to perform any action.

On-line shopping systems allow customers to shop in one or more stores that are implemented as Web servers on the Internet. A customer can browse information on the Web servers that describe products available from the stores. When a desired product is found, the user can place the product into a “virtual shopping basket.” The virtual shopping basket is implemented as a set of cookies that are sent to the client computer system and stored on the client computer system. At check-out time, the customer pays for the selected products using some type of payment system such as a credit card. After payment is received, the on-line shopping system notifies the stores to ship the selected products to the customer.

The customer uses Web browser software to access an on-line “merchant” server that is operated by a merchant having products to sell. This merchant server is a server computer system. Specifically, the browser software sends an http request for the home Web page of a merchant Web server. The merchant Web server responds to the request with an HTML document that is displayed by the browser. The home Web page contains information about the merchant and its products (e.g., shoes, hats, shirts, etc.). The home Web page can implement a set of linked Web pages that describe the products that are available from the merchant. Each product may be associated with its own HTML document that fully describes the product. Products can be described using text, images, sounds video clips, and any other communication form supported by Web browsers. The user can continue browsing through Web pages of the merchant server by repeating these steps. After browsing through the Web pages provided by the server, the customer may select a product by, for example, “clicking” (in the conventional manner) on an image of a product that causes the browser to request a Web page that fully describes the product. If the customer wishes to buy shoes from the merchant, the customer could click on a “buy it” button. The merchant server then sends an HTML form document that requests the customer to send necessary details for the purchase). For example, the customer may select a quantity, a desired style, and size of the product as requested by the form document. The browser then sends a POST command under HTTP, which transmits the data entered into the form to the merchant server. The data on the submitted form (e.g., quantity, size, style, etc.) is analyzed by the server and the transaction is processed. The server then generates a synthetic page and sends it to the browser running on the client system. This synthetic page preferably contains a thank you note along with confirmation information. Cookies containing information describing the selected product are also sent at this time. The browser software running on the client system stores the cookies describing the selected products within the client computer system. The stored cookies include an identification of the contents of a virtual shopping basket that contains the products selected by the consumer. In an embodiment of the present invention, the cookies are stored in a file located in a storage medium (such as a hard disk) of client computer system. The time interval for storing the cookies that describe the selected products can be set to any desired length. In one embodiment of the present invention, the cookies are deleted when the customer exits from the browser. This can be accomplished by not setting the “expires” attribute of the product description cookies. In another embodiment of the present invention, the cookies are kept valid (prior to their expiration) even after the customer exits from the browser and turns off computer. This can be accomplished by setting the “expires” attribute of the product description cookies to a later date.

When the customer desires to buy the products, the customer accesses a link that identifies a “check-out” Web page. The check-out Web page causes the browser to send all the product description cookies. Thus, the check-out Web page empties out the virtual shopping basket. The merchant server generates a total bill for all the products in the virtual shopping basket. The server may then request billing information (e.g., credit card number) and shipping (e.g., address) information from the customer using a form. In a preferred embodiment the transaction of credit card information is transmitted using a secure medium. The transaction server then performs a real-time credit card authorization. Once the transaction is authorized, transaction server sends messages to individual merchants to fulfill the order.

It is desirable to provide a system and method to facilitate online sales. The growth of online sales has been hampered by a number of factors including but not limited to:

Reliability of online retailers

Acceptance of the security of purchasing online

Brand recognition of online retailers

Shipping costs

Complicated process

Language issues (in a non English speaking environment)

Customer service

Product returns

Desire to touch and feel products.

To meet these needs, several companies are actively pursuing strategies that will allow them to differentiate themselves in a highly competitive industry that is currently reassessing its strengths and refocusing its approach. More and more players are developing strategies for integrating online and offline economies. Examples can be found of online retailers partnering with traditional retailers (“brick and mortar”) in order to benefit from their infrastructure, buying power and physical locations. Nonetheless, the existing services do not meet all the needs of the customers. Overall, the current players lack the vision of how to structure their offer through the internet transition that is reshaping the retail industry. Despite these evolutions, the majority of consumers are not convinced that the internet represents a new channel to meet their purchasing needs.

Various computerized systems have been developed to facilitate shopping over the internet. Some relate to the delivery of information to remote customers while other require customers to place orders and place orders over the Internet. See for example U.S. Pat. Nos. 4,528,643 (Freeny) 5,715,314 (Payne et al), 5,826,242 (Montulli), 5,905,973 (Yonezawa), 5,909,492 (Payne).

Others relate to hand held devices used by consumers in stores. See U.S. Pat. Nos. 6,101,483 (Petrovich et al) and 5,918,211 (Sloane).

Kiosks placed in high traffic areas have also been suggested. See U.S. Pat. Nos. 5,826,267 (McMillan) and 5,950,173 (Perkowski).

John Kenney (U.S. Pat. No. 6,026,376) has even suggested the creation of a virtual store including a visual representation of a “real” store.

There is a need to combine the use of remote systems and in store systems to greatly improve the shopping experience of consumers.

### OBJECTS OF THE INVENTION

It is, therefore, an object of the invention to provide physical points of service to represent online retailers, thereby becoming an outsourcing solution for their store presence.

It is a further object of the invention to offer to consumers and online retailers a national network of physical stores/kiosks located in commercial locations where the social experience of shopping will be merged with the convenience of e-commerce. The stores or kiosks will be staffed with trained sales assistants and feature web terminals where consumers will be assisted in purchasing products and services online at the participating merchant sites.

It is another object of the invention to provide a human presence in kiosks or stores located in prime shopping malls or other locations using multimedia terminals.

It is a further object of the invention to support the site with a website/portal that can be accessible by personal computers, mobile phones and other similar devices.

It is still another object of the invention to provide an electronic commerce computer platform providing a range of business services including but not limited to information collection & processing, sales of goods, sales of services, sales of electronic information, processing returns and offering pick-up services.

It is yet another object of the invention to physically display selected products in kiosks/stores which the customer can buy online.

Yet a further object of the invention is to provide connected peripheral services: printing, downloading, scanning & video conferencing.

It is another object of the invention to use our physical presence to promote & implement e-commerce solutions for local businesses and organizations.

Another object of the invention is to ask participating retailers for a welcome fee and a rental fee paid by physical location based on the amount of product categories maintained on the system's web site. A sales commission will be applied above a predetermined sales level.

### BRIEF DESCRIPTION OF THE DRAWING

The present invention will be understood and appreciated more fully from the following detailed description, taken in conjunction with the drawings in which:

FIG. 1 is a schematic view of a topology showing parts of the invention;

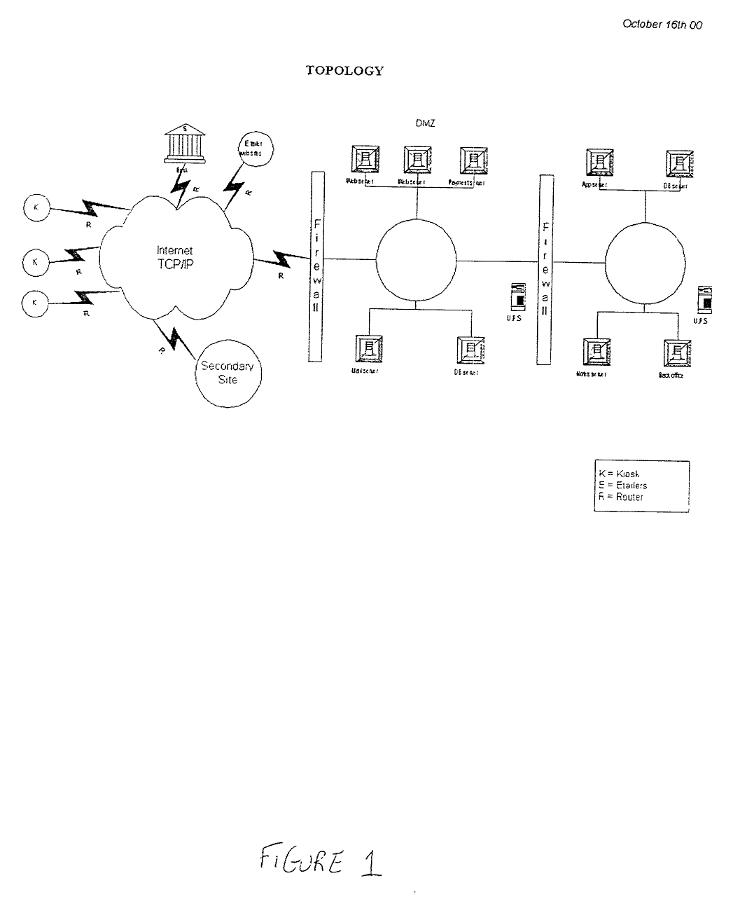

FIG. 2 is a perspective view of the layout of a store/kiosk used in conjunction with the invention;

FIG. 3 is perspective view of a second layout of a store/kiosk used in conjunction with the invention.

### DESCRIPTION OF THE INVENTION

For all consumers, not just existing internet users, the system and method offers, the opportunity to benefit from a wider selection of products and the price competitiveness offered by participating online retailers. The staff at each store/kiosks will respond to any concerns over security, privacy, pricing and delivery as well as helping with the purchase process. Each store/kiosks will accept returns and represent the participating online retailers. The service will preferably be free for the consumer.

Described hereunder are 3 examples of sales scenarios:

i. New customer wants to buy a new digital camera

Record customer data,

Product specification,

Consumer reports,

Price by preferred supplier,

Check it's reasonable price,

Add product to basket,

Attempt add-on sales.

ii. Customer wants to learn how to find best travel bargains on internet

Record customer data,

Determine the sort of travel requirements (package, flights, hotel etc only),

Walk customer through the best sites,

Suggest return to make booking.

iii. Customer wants to return a product for wrong size

Note: If product bought through one of the participating locations the size will be checked before ordering,

Customer arrives with the product and invoice/packing slip,

Suggest alternatives to return,

Fill-out e-tailer on line return form and place new order,

Send goods to e-tailer.

Detailed Service Description

Products will be offered to consumers and to businesses. The offerings will be split into two priorities, primary and secondary to indicate their anticipated importance to the business and time of introduction.

1. Consumer Products

i. Primary

a) Sales through our proprietary virtual mall,

b) Process returns for merchandise from affiliated merchants,

c) International shipping,

d) Community virtual web boards.

ii. Secondary

a) Sales of internet connections,

b) Sales through non-affiliated merchants,

c) Sales other complementary products (CDs for downloading etc. . . . ),

d) Web consulting services (research, setting up web page, other),

e) Video conferencing,

f) Peripheral services (colour printing, CD burning, digital photos),

g) Delivery/Pick-up address for products,

h) Ad hoc web surfing.

2. Business Products

i. E-tailers

a) Primary

1. Membership of our virtual mall,

2. Benefits of sales skills of our staff,

3. Agency services of our stores (returns, complaints etc. . . . ),

4. Feedback data from our customers (why buy, why not buy, like/dislike site),

5. Advertising on our site,

6. Advertising in store,

7. In store promotions and displays,

8. Shipping assistance.

b) Secondary

9. Referral to sites (leads),

10. Promote local web services (web design, training),

11. Provide a service to get local retailers online.

For the participating retailers the stores/kiosks represent a much-needed “brick for clicks”, a physical point-of sale/service, the “brick” for member online retailers, the “clicks”.

The selected retailer partners will preferably pay rental per physical location based on the number of product categories they sell. The number of retailers per category will preferably be restricted. Advertising opportunities in the store or website/portal will be available to retailers.

Participating retailers will be the leader in each of their categories and offer the best in product selection, price, security and delivery.

Briefly, therefore, this invention provides for a system and method to facilitate e-commerce transactions, between a plurality of retailers and at least one customer. The commercial transactions occur at a physical point of service in high traffic locations, using personal computer stations connected to the internet. Each kiosk or store includes workstations including hardware and software to enable customers to enter information and carry out purchases at the merchant web site. Each site typically also includes the presence of at least one trained assistant capable of leading and reassuring the customer. In addition, each workstation will be equipped with a printer generating receipts and means of carrying out credit/debit/check transactions such as a Magnetic Swipe Reader.

The system of the invention enables the display of product information by category for ease of use by the customer. Similarly, items from various retailers can be displayed as images for the customer to browse. The displayed products will also include photos, descriptions, prices & customer/product reviews.

Store Design

The store design is a key element to attracting clients and building brand awareness. An examples are shown in FIGS. 4 and 5.

The stores will have the following key design elements:

1. Design statement representing the internet nature of the business,

2. Interactive workstations,

3. Screens for displaying services, e-tailer sites and promotions,

4. A services desk for receiving clients,

5. Display area of e-tailer merchandise and, if advisable, of merchandise sold directly by the Internet Service Centre.

As the Internet Service Centres will be in varied locations with different dimensions, various concepts may be envisaged such as:

Kiosk (average size 300-500 sq ft),

Mobile—for visiting rural areas and retirement homes,

Stand alone store (average size 800-1000 sq ft).

In addition, a customer information database stores information relating to the customer. This database can be monitored for commercial purposes. Once the customer completes a purchase transaction (“check-out” process), pricing information will include shipping fees & customs/taxes to display the final price to be paid in the customer's currency. This “check-out process” could take place at the retailer web site.

Once the check-out is completed, the retailer will provide the customer with a tracking number to trace and track the delivery of purchased items.

Customers will also be able to access the website/portal of the invention's operator from their own PCs/portable devices as well as physically at the point of service (kiosk/store).

Finally, if the product needs to be returned, it could be brought back to such kiosks/stores which will process the return in accordance with the merchant terms & conditions.

Web site

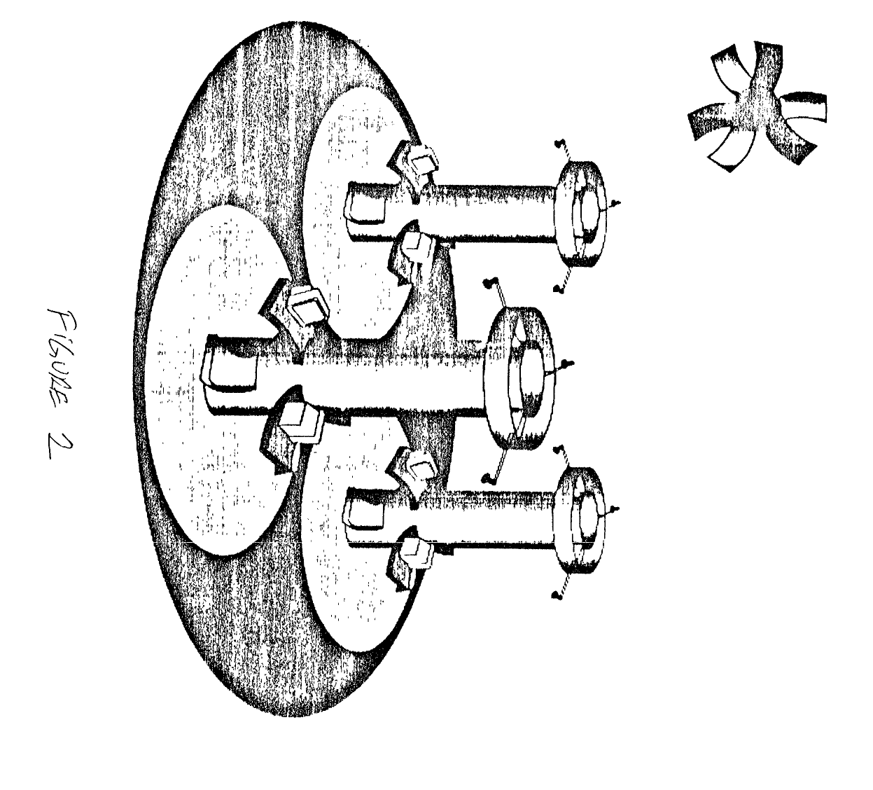

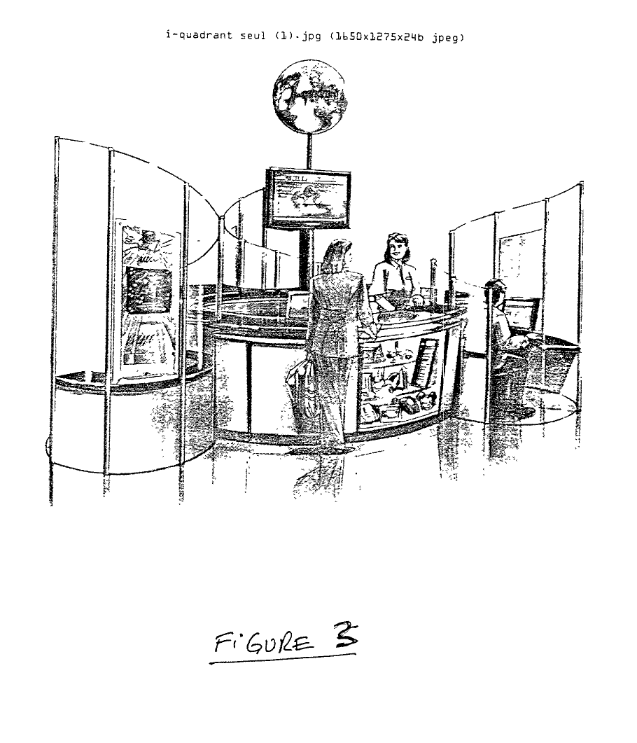

The web site may be separated into as number of sections (set FIGS. 2 and 3 for examples);

About us: Will inform web surfers about the mission, the team and the IT infrastructure. This section will also give the user the possibility to send an information request.

Virtual mall: Section for any web users who wants to “see” the shopping services. The user could select a product category and browse through a picture including a brief description and the price information. A shopping cart with payment functionality will be standard.

The initial functionality will allow the customers to shop by size, product category and sub-category. For the selected category the customer will see individual products with the price, colour, and availability. Links will point to product reviews. The customer will do the checkout at the e-tailer site.

In a subsequent phase, rules matching (personalization) a more dynamic site will allow the participant to do up selling by suggesting a complementary product or service.

Merchant section: Information section for all member e-tailers: customer data, updates, new features, markets trends etc. A merchant only billboard section will also be available.

Also, the kiosk/store can access a knowledge database to resolve all IT questions through a call tracking application (see appendix for “Problem Resolution Process” diagram). After a period of time, any open ticket without a known solution will be automatically escalate to a help desk agent. A more business-oriented sub-section will also advertise head office messages, e-retail topics, popular links etc. . . .

News: Section containing recent articles, ad's campaign highlight and video presentation.

Employment-careers: All job posting with description and an integrated e-mail request form.

Community Board: community events, classifieds, etc retailers.

An example of such c-site is shown in FIG. 2. FIG. 3 show certain distinction with a known site.

Virtual mall application

Customer data will be entered once only to allow a quick checkout and to customize product offerings to the customer profile. For example the internauts will take all customer measurements and enter them into the system.

A user-friendly interface will guide the shopper through a standard product categories. Product selection will be made exclusively with our e-retailers.

To reduce development time, a standard credit authorization application will be used at the beginning until our own payment application is certified with a banking institutions. As soon as more new retailers will join the virtual mall, customers buying history will allow to propose personalized offerings to each customer depending on their purchase habits.

Operations

The help desk operations will reside in the integration of a knowledge base system with a call tracking application.

As soon as a problem is opened, the knowledge base will provide end users (head office, technicians, merchants and kiosks) with a resolution tree for all problems with a know resolution. Any problems without a solution or intermittent problems will automatically be escalated to a higher level until final and complete resolution. At all times, help desk agents will have remote access capabilities (remote screen control) to resolve and help the kiosks and their clients.

Development

Future development for the web site may include:

Personalization: product matching upon purchases history.

Matching: Up-selling capabilities based on quantifiable criteria (frequency, buying partner/scheme, product category etc. . . . ).

Community interests: frequent update, news, and articles to have new content on a daily basis.

Dynamic rules: Different interface depending on customer profile (kiosk, new visitors, merchant, customers, investors etc).

Remote training: video conferencing, 3D or Avid™ animation, on-line training session.

Shockware™ demo: products and services.

Flash™ integration: automatic Flash 4.0 download and Flash animation.

Shopping card: past transactions, suggestions, daily specials.

E-mail: Automated new e-mail notice when navigating on site. Remote access capabilities from any location.

Chat: scheduled interactive chat with special guests and video support at kiosk locations.

Billboard: posting customers, kiosks, merchants and visitors on a managed billboard.

This system may utilize the infrastructure of a franchise chain for order taking and delivery and for realizing a service business including information collection and processing, sales of goods, sales of electronic information, referral services, and information services using the Internet and other communications systems.

While certain embodiments of the present invention have been shown and described, it is to be understood that many changes and modifications may be made thereto without departing from the spirit and the scope of the invention defined in the appended claims.

We claim:

1. An on line computerized shopping system, comprising:
a) at least one web server on which data items corresponding to a product or service are stored;
b) at least one store system located at a physical site remote from the web server;
c) a data communication network adapted to connect said user system to said web server;
d) means to exhibit at least one product at said physical site.

2. physical kiosk/store with the following primary product offering to consumers:
a) sales through our proprietary virtual mall,
b) process returns and refunds for merchandise from affiliated retailers,
c) international shipping,
d) integration of wireless systems,
e) ability to pay using debit or credit,
f) demonstration point for new technology,
g) demonstration point for new products and services,
h) store assistance,
i) product availability.

3. An internet service center with the following secondary product offering to consumers:
a) sales through non-member retailers,
b) web consulting services (research, creating & hosting web pages, other),
c) peripheral services (color printing, cd burning, digital photos, email attachments, free email accounts, file transfers, upgrades from network),
d) local community web boards,
e) pick-up services.

4. An internet service center with the following primary product offering to online retailers:
a) membership of our virtual mall,
b) benefits of sales skills of our staff,
c) agency services of our stores (returns, complaints etc. . . . ),
d) feedback data from our customers (why buy, why not buy, like/dislike site),
e) advertising on our portal/website,
f) in store advertising,
g) in store promotions and displays,
h) logistics solutions.

5. An internet service center with the following secondary product offerings to online retailers:
a) promote local web services (web design, training, hosting),
b) provide a service to get local retailers online.

6. A virtual mall laid out by category or department as follows:
a) department,
b) category,
c) sub-category,
d) class (brand/color/size),
e) result of search (photo/availability/shipping costs/ship to region flag/shipping time) (link to product reviews),
f) add to basket,
g) search for other items,
h) complete check-out at each store but enter details once (use of existing software).

7. In the following virtual mall application:
a) customer data will be entered once only to allow a quick check-out and to customize product offerings to the customer profile (use of virtual wallet),
b) a user-friendly interface will guide the shopper through standard product categories. Product selection will be made exclusively with participating online retailers.
c) Customers buying history will allow us to propose personalized offerings to our customers depending on their purchase habits.
d) Customer login with security and options to change/modify own profiles (address, shipping address, telephone numbers etc. . . . )

8. A proprietary web site including:
a) Free email account accessible anywhere in the world,
b) customization: product matching upon purchases history,
c) matching: up-selling capabilities based on quantifiable criteria (frequency, buying partner/scheme, product category etc. . . . ),
d) provide personalized content based on interest or purchase habits,
e) community interests: frequent update, news and articles to have new content on a daily basis,
f) dynamic rules: different interface depending on customer profile (new visitors, retailers, customers, investors etc. . . . ),
g) remote training: video conferencing, 3D or Avid™ animation, on-line training session,
h) shockwave™ demo: products and services,
i) flash™ integration: automatic flash 4.0 download and flash animation,
j) shopping card: past transactions, suggestions, daily specials,
k) email: automated new email notice when navigating on site including remote access capabilities from any locations,
l) chat: scheduled interactive chat with special guests and video support at point of service locations,
m) billboard: posting customers, retailers and visitors on a managed billboard,
n) publicity/promotion,
o) content updates,
p) online shopping,
q) loyalty schemes.

9. A method for on-line shopping comprising the following steps:
a) maintaining an actual physically embodied shopping facility in which a shopper can purchase from among a plurality of products,
b) selecting, by communication over a communication link between a user computer and a server computer, a shopper's choice of products,
c) creating within one of said computers in response to the indicated selections a list of selected products and organizing the list in sequential order in which the selected products are to be picked up at the actual shopping facility.

10. An on-line shopping system that features the ability to provide or refer the goods and services of contents partners to customers through multimedia terminals at a plurality of stores in addition to personal computers, mobile phones and other similar devices.

11. An order taking, settlement and delivery system that has diversified methods of payment by including cash payment at a plurality of stores with credit and pay-on-delivery and that makes it possible to select the method of delivery from either home delivery or pick up at such stores.

12. A commission system whereby the operator of the system pays commission fees to stores operators according to its frequency of use of the store network.
